(19) United States
(12) Patent Application Publication
(10) Pub. No.: US 2024/0123292 A1
(43) Pub. Date: Apr. 18, 2024

(54) FITNESS TRAINING APPARATUS, AND COMPUTER-IMPLEMENTED METHOD AND SYSTEM OF FITNESS TRAINING

(71) Applicant: VITRUVIAN INVESTMENTS PTY LTD, Perth (AU)

(72) Inventor: Jonathan Charles GREGORY, City Beach (AU)

(21) Appl. No.: 18/264,031

(22) PCT Filed: Feb. 3, 2022
(86) PCT No.: PCT/AU2022/050055

§ 371 Date: Aug. 2, 2023

(30) Foreign Application Priority Data
Feb. 4, 2021 (AU) 2021900255

(51) Int. Cl. A63B 24/00; A63B 21/00; A63B 21/005; A63B 23/035; A63B 23/12

(52) U.S. Cl. CPC A63B 24/0087; A63B 21/0058; A63B 21/153; A63B 21/4033; A63B 23/03541; A63B 23/1281; A63B 2024/0068; A63B 2024/0093; A63B 2220/35; A63B 2220/51; A63B 2220/833; A63B 2225/20; A63B 2225/50

(57) ABSTRACT

In one aspect and embodiment, the present invention provides a fitness training apparatus comprising: a controller configured to communicate instructions to a load generator to apply a selectively adjustable load to at least one retractable line provided in or on a base. The retractable line has a free end region, wherein the at least one retractable line being extendible from a retracted state to an extended state upon application of a force to the free end region, wherein the load applied to the at least one retractable line acts against the force applied to the free end region. The controller is configured to perform operations comprising: setting a target speed band for the at least one retractable line; receiving a speed of the at least one retractable line; and responsive to comparing the speed of the at least one retractable line to the target speed band, modifying the selectively adjustable load to the at least one retractable line to maintain the target speed band.

### FIELD OF THE INVENTION

The present invention relates to a fitness training apparatus and an associated fitness training system.

### BACKGROUND OF THE INVENTION

Fitness training for maintenance and improvement of personal health and well-being has become increasingly popular in developed societies in the past several years. And during this period, there have also been accompanying developments in equipment and apparatuses for training popular exercises, such as running, cycling and rowing. In particular, a wide variety of treadmills, training cycles, and rowing machines have been developed for use both in the home and in fitness studios for individual or group training classes.

One area of fitness training that has perhaps experienced less development in new equipment and apparatuses for popular exercises is weight-training. In this regard, free-weights (such as dumbbells, barbells, and kettlebells) are still common in fitness studios. And although a wide variety of different weight-machines are also known, each of these is usually designed for performing only a small and specific group of exercises, making a collection of different weight-machines necessary for a general or “all-round” workout.

A need therefore exists for a new and improved fitness training apparatus that is able to replace or substitute for a variety of known weight-training equipment. It would also be desirable to provide such an apparatus that could be used in a group or class training environment and/or in an internet-enabled connected fitness environment. In view of the above, it would be useful to provide a new and improved fitness training apparatus and an associated fitness training system.

### SUMMARY OF INVENTION

According to one broad aspect, the present invention provides a fitness training apparatus comprising
a base;
at least one retractable line provided in or on the base, the retractable line having a free end region for operation by a user, wherein the at least one retractable line is configured and arranged to be extended from a retracted state in or on the base to an extended state upon application of a force to the free end region of the retractable line by the user;
a load generator provided in or on the base for applying a selectively adjustable load to the at least one retractable line, wherein the load applied to the retractable line by the load generator resists or acts against the force applied to the free end region by the user for extending the retractable line from the retracted state to the extended state.
a processor for receiving data regarding the operation of the fitness training apparatus; and
a transmitter for transmitting information about the operation of the fitness training apparatus to a remote device.

According to a further broad aspect, the present invention provides a fitness training apparatus comprising:
a controller configured to communicate instructions to a load generator to apply a selectively adjustable load to at least one retractable line provided in or on a base, the retractable line having a free end region, the at least one retractable line being extendible from a retracted state to an extended state upon application of a force to the free end region, wherein the load applied to the at least one retractable line acts against the force applied to the free end region, wherein the controller is configured to perform operations comprising:
   setting a target speed band for the at least one retractable line;
   receiving a speed of the at least one retractable line; and
   responsive to comparing the speed of the at least one retractable line to the target speed band, modifying the selectively adjustable load to the at least one retractable line to maintain the target speed band.

In this way, the invention provides a fitness training apparatus with at least one retractable line with which a user can perform exercises against a selectively adjustable load provided by the load generator. In particular, the force typically required, in use, for application to the free end region by the user for extending the retractable line from the retracted state to the extended state exceeds the load being applied to the retractable line by the load generator. Also, the at least one retractable line is preferably configured to be retracted from the extended state to the retracted state by the load applied by the load generator. Accordingly, in use, the force applied to the retractable line by the user while performing exercises will typically oppose and/or resist the load being applied by the load generator for retracting the retractable line to the retracted state.

In a preferred embodiment, the controller comprises one or more sensors for sensing use or operation of the at least one retractable line, including sensing the speed of the at least one retractable line. Alternatively, or in addition, in a preferred embodiment the controller comprises one or more sensors for sensing use or operation of the at least one retractable line, including sensing one or more of a current position, a motion, a speed, or an extension of the at least one retractable line, wherein the controller is configured to adjust the load applied to the at least one retractable line by the load generator in dependence on the use or operation of the at least one retractable line. The controller may be configured for communication with a user device for one or more of input of training settings by the user or displaying training information to the user during training.

In a preferred embodiment, the base of the fitness training apparatus is adapted or designed for supporting the apparatus on a support surface, which may, for example, be the floor of a training room. In this context, the base may include wheels or casters to assist a user to move the apparatus over the floor of a training room. Depending on the intended use of the training apparatus, however, the base may be adapted or designed for supporting the apparatus on a vertical support surface, such as a wall. In this regard, the base may be configured to be securely fixed or mounted to the support surface.

In a preferred embodiment, the base of the fitness training apparatus provides a training platform for the user. In this regard, the base may be configured to support the user while he/she is performing training exercises. In other words, the user may stand, sit, or lie on the base as a training platform while performing training exercises. In a particularly preferred embodiment, the base or training platform is configured as a step or platform upon which a user may stand while performing training exercises. The step has a height that is preferably in the range of about 100 mm to about 400 mm, more preferably in the range of about 200 mm to about 300 mm. In this way, the at least one retractable line is preferably configured and arranged to be extended from the retracted state in a direction away from the base, preferably in an upwards or vertical direction, or through any of a range of angles to the vertical direction.

In a preferred embodiment, the base of the fitness training apparatus includes a portion that is removable or separable to form a training bench for the user. The portion of the base for forming the training bench preferably has a length in the range of about 500 mm to about 1000 mm. The portion of the base for forming the training bench also preferably has foldable legs.

In a preferred embodiment, the base of the fitness training apparatus includes a frame for mounting and supporting the load generator thereon and a casing to enclose and house the load generator and the at least one retractable line in its retracted state.

In a preferred embodiment, the at least one retractable line is flexible and is arranged to retract into a wound or coiled configuration in the retracted state, preferably onto a spool or drum that is provided in or on the base, e.g. mounted and supported on the frame of the base. The at least one retractable line preferably comprises any one of a cable, a cord, a rope, a strap, or a band. The at least one retractable line is configured for attachment of a handle at the free end region thereof for manual operation by a user. To this end, the free end region of the retractable line may comprise a clip or clasp for attachment of a handle to be grasped by the user during training; i.e. for applying force (tension) to the retractable line as it is extended and retracted. The handle may have a hand-grip that is sized or configured for one-handed operation of the retractable line. As an alternative, the handle may have a hand-grip sized or configured for two-handed operation of the retractable line. The handle may also be provided in the form of a bar for connection with either a single retractable line, or with multiple retractable lines (e.g. with two retractable lines—one connected at each of the opposite ends of the bar).

In a preferred embodiment, the load generator of the fitness training apparatus comprises at least one electric motor, desirably a torque motor, that is variably operable to generate a range of torques for applying the selectively adjustable load to the at least one retractable line. A torque motor is a specialized form of electric (DC) motor that can operate while stalled, i.e. with the rotor prevented from turning. In this mode of operation the motor continues to apply a steady torque. In a preferred embodiment, the spool or drum on which the retractable line is wound or coiled in the retracted state is provided or mounted on a shaft coupled with a rotor of the at least one electric motor. The shaft may be coupled directly to the rotor or coupled via a transmission, e.g. a belt and pulley transmission or, more preferably, a toothed-belt (or chain) and sprocket transmission.

In a preferred embodiment, the load generator of the fitness training apparatus is configured or controlled to adjust the load applied to the at least one retractable line during extension of the retractable line to the extended state and/or during retraction of the retractable line to the retracted state. In this way, the load applied to the retractable line by the load generator (e.g. via the at least one electric motor) may be held constant, increased, and/or decreased as the line is extended under the force applied by the user and/or as the line is retracted against the resistance force applied by the user. The adjustability of the load over the stroke or movement of the retractable line in this way enables the training to be tailored not only to the individual person, but also to a specific exercise being trained and its associated biomechanics. Thus, the load generator can be controlled to provide eccentric loading, concentric loading, and/or isometric loading. In this regard, the fitness training apparatus preferably comprises a control device—e.g. provided in or on the base—having one or more sensor(s) for sensing use or operation of the or each retractable line, such as current position, motion, speed, force, and/or extension of each retractable line. The control device may be configured to adjust the load applied to the or each retractable line by the respective load generator in dependence upon the use or operation of the or each retractable line.

In a preferred embodiment, the control device is configured for communication with a user device, such as a smart phone and/or a display monitor, for input of training settings by the user and/or for displaying training information to the user during training. The control device preferably includes a processor, an electronic data storage, and/or wireless communication hardware.

In a particularly preferred embodiment, the fitness training apparatus comprises two retractable lines provided in or on the base, and two load generators provided in or on the base, each load generator being operatively associated with a respective one of the two retractable lines. The retractable lines may be arranged spaced apart from one another by a distance in the range of about 0.8 m to 1.6 m, preferably about 1.0 m to 1.4 m, especially where the base is configured as a step or platform upon which a user may stand while performing training exercises. The base may be adjustable to vary the distance by which the retractable lines are spaced apart from one another.

Thus, according to at least one embodiment, the present invention provides a fitness training apparatus comprising:
a base configured as a platform upon which a user may stand while performing training exercises;
two retractable lines provided in or on the base, each retractable line having a free end region for operation by a user, wherein each retractable line is configured and arranged to be extended from a retracted state in or on the base to an extended state upon application of a force to the free end region of the respective retractable line by the user; and
two load generators provided in or on the base, each load generator being operatively associated with a respective one of the two retractable lines, for applying a selectively adjustable load to each retractable line, wherein the load applied to each retractable line by the respective load generator resists or acts against the force applied in use to the free end region by the user for extending the retractable line from the retracted state to the extended state.

In a preferred embodiment, each retractable line is provided or incorporated in the base, with the free end of each retractable line emerging from an outer (e.g. upper) surface of the base for access and operation by the user. A path of travel of each retractable line is guided by one or more pulleys mounted in or on the base. A pulley for guiding the path of travel of each retractable line into the retracted state is preferably configured to pivot or swivel to promote even spooling of the line as it retracts.

According to another aspect, the present invention provides a fitness training system comprising:
a fitness training apparatus of the invention as described above, and according to any one of the embodiments; and
a user device, such as a smart phone or a display monitor, for communication with the apparatus, preferably with a control device of the apparatus, for input of training settings by the user and/or for displaying training information to the user during training.

In a preferred embodiment, the user device comprises software executing on the user device for communication with the controller. The controller may be configured to set the speed band responsive to receiving an input of a velocity target training setting. The target speed band may be defined by a minimum velocity and a maximum velocity. Modifying the selectively adjustable load to maintain the target speed band may comprise varying the load according to a function, which may comprise a linear or log function.

In a preferred embodiment, the one or more sensors comprise at least a rotary encoder for detecting rotation of a spool or drum for determining the speed of the at least one retractable line as it is extended from or retracted onto the spool or drum. The controller may modify the load applied to the at least one retractable line at regular intervals or at discrete times.

In a preferred embodiment, the at least one retractable line is connected with at least one end of a bar to enable performance of squat exercises. Additionally, a handle may be connected to the free end of the at least one retractable line, wherein the handle comprises a cuff to enable performance of arm curl exercises.

The fitness training system of the invention is thus preferably internet-enabled, via the fitness training apparatus (e.g. the control device of the apparatus) itself or via the user device, such as smart phone and/or display monitor, with which the user device is in communication. In this way, the system may connect a user to an interactive fitness environment. For example, the user may receive audio and/or visual input for one or more training regime via the user device. Furthermore, the user may be connected via the user device to a group or class training environment—either real or virtual.

In a preferred embodiment, the fitness training system comprises a software application for installation on the user device for communication with the apparatus for input of training settings and/or for display of training information to the user. In this way, the software application is configured to provide a user of the fitness training apparatus with user input (i.e. audio and/or visual user input) during use of the apparatus. This input may, for example, be in the form of instruction and/or motivation for any one of a number of specific training regimes. To this end, the control device of the fitness training apparatus and/or the user device is preferably configured for connection to the internet for either or both of downloading information for display to the user via the user device, and uploading information from the apparatus and/or from the user's training area for display to the user and/or for transmission to co-participants in a group or class training environment.

The fitness training system of the invention is therefore preferably configured to enhance the overall training experience for the user by connecting the user with training instruction, with training motivation, and/or with a group or class training environment—whether real or virtual.

In a preferred embodiment, the fitness training system comprises one or more accessory devices for user input (such as a camera and/or a microphone) and/or for output to the user (such as speakers and/or lighting). The accessory devices may be integrated in the user device or may be separate. The fitness training system may also include a remote control (e.g. in addition to touch-screen actuation), optionally with IR input, and power/volume control in order for the user to operate the user device and/or accessory device(s) remotely during use of the fitness training apparatus.

In a preferred embodiment, the control device of the apparatus is configured to calculate training performance from the use or operation of the or each retractable line sensed or detected by one or more sensor(s) of the control device for display on the user device. In this way, the control device may output information to the user device for display to the user during training, thereby providing useful training feedback.

According to a further broad aspect, the present invention provides a method comprising:
setting, by a controller of a fitness training apparatus, a target speed band for a retractable line of the fitness training apparatus;
receiving, by a controller of a fitness training apparatus and from a sensor device, a speed of the retractable line;
responsive to comparing the speed of the retractable line to the target speed band, modifying, by the controller of the fitness training apparatus, a selectively adjustable load to the retractable line to maintain the target speed band, wherein modifying the selectively adjustable load comprises communicating instructions to a load generator to modify the selectively adjustable load to the retractable line.

In a preferred embodiment, setting the target speed band comprises receiving, from a user device, instructions to apply a targeted velocity mode for the fitness training apparatus. Modifying the selectively adjustable load to maintain the target speed band may comprise varying the load according to a function. The function may comprise a linear function or log function.

In a preferred embodiment, the sensor comprises a rotary encoder for detecting rotation of a spool or drum for determining the speed of the retractable line as it is extended from or retracted onto the spool or drum.

### BRIEF DESCRIPTION OF THE DRAWINGS

For a more complete understanding of the invention and advantages thereof, exemplary embodiments of the invention are explained in more detail in the following description with reference to the accompanying drawing figures, in which like reference signs designate like parts and in which:

FIG. 1 is a schematic cross-sectional view of a fitness training apparatus according to one preferred conceptual embodiment of the invention;

FIG. 2 is a perspective view of a fitness training apparatus according to a preferred embodiment of the invention;

FIG. 3 is a front view of the fitness training apparatus of FIG. 2, illustrating separation of an upper portion of the base;

FIG. 4 is a perspective view of the fitness training apparatus of FIG. 2, showing the upper portion of the base converted into a bench;

FIG. 5 is a perspective view of an interior of a base of the training apparatus according to one preferred embodiment;

FIG. 6 is a perspective view of an interior of a base of the training apparatus according to another preferred embodiment;

FIG. 7 is a perspective view of an interior of a base of the training apparatus according to a further preferred embodiment;

FIG. 8 is a perspective view of an interior of a base of the training apparatus according to yet another preferred embodiment;

FIG. 9 is a cross-sectional perspective view of a fitness training apparatus according to the embodiment of FIG. 8;

FIG. 10 is a partial perspective underside view of the fitness training apparatus shown in FIG. 9;

FIG. 11 is a schematic view of the fitness training apparatus according to one embodiment of the present invention which utilises a direct drive motor;

FIG. 12 is a graph view showing a bicep curl exercise according to one aspect of the present invention;

FIG. 13 is a schematic view showing a force cube according to one aspect of the present invention;

FIG. 14 is a schematic view showing a force cube for a particular exercise according to one aspect of the present invention;

FIG. 15 is a schematic view showing a force cube for a particular exercise according to one aspect of the present invention; and

FIG. 16 is a block diagram of an exemplary computing device capable of performing software related aspects of the present invention.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will also be understood that certain actions and/or steps in an embodiment of a method may be described or depicted in a particular order of occurrences while those skilled in the art will understand that such specificity with respect to sequence is not actually required.

### DETAILED DESCRIPTION OF THE EMBODIMENTS

The present invention will first be described with reference to its hardware structure, followed by description of its software structure and ecosystem within which software may communicate.

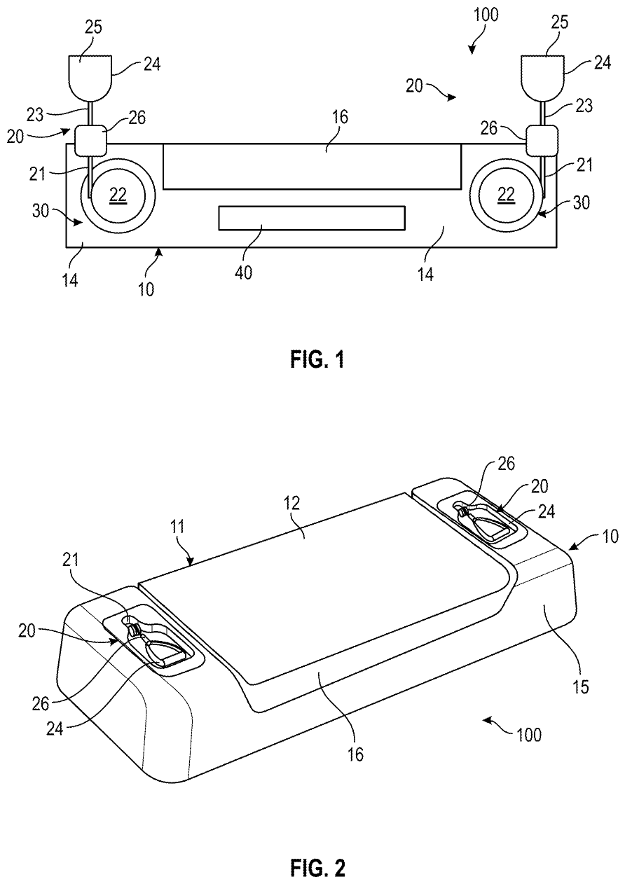

With reference to FIGS. 1 to 4 of the drawings, a fitness training apparatus 100 according to a preferred embodiment of the invention will be described with reference to both its conceptual design in FIG. 1 and a preferred configuration in FIGS. 2 to 4.

Referring firstly to the drawing FIGS. 1 and 2, the fitness training apparatus 100 comprises a base 10 configured as a platform or step upon which a user (not shown) may stand, sit, or lie while performing training exercises. An upper surface 11 of the base 10 has a layer 12 of rubberised material to provide grip and optionally also some degree of cushioning and/or comfort for the user when he or she stands, sits, or lies on the upper surface 11. In this example, the base 10 of the fitness training apparatus 100 is adapted or designed to support the apparatus on a generally horizontal support surface S, such as the floor of a training room. The base includes wheels or casters 13 which assist a user to move the apparatus 100 over the floor of a training room.

The fitness training apparatus 100 comprises two retractable lines 20 provided in the base 10. In this embodiment, each retractable line 20 comprises a thin, flexible cable 21 of a generally circular cross-section coated or covered with a plastic sheath, although a cord or rope may be equally suitable. Each retractable line 20 (i.e. cable 21) is configured and arranged to retract into a wound or coiled configuration in a retracted state on a spool or drum 22 provided in the base 10, i.e. mounted and supported on a frame 14 of the base 10. Each cable 21 typically has an unwound length of less than or equal to 2 metres. In this way, each retractable line 20 is provided in the base 10, with a free end region 23 of each retractable line or cable emerging from the upper surface 11 of the base 10 for access and operation by the user. To this end, the free end region 23 of each cable 21 is configured (e.g. with a clip or clasp) for removable attachment of a handle 24 for manual operation by the user. In this example, each of the handles 24 has a hand-grip 25 sized or configured for one-handed operation of the retractable line. In this way, each retractable line 20 is configured to be extended from the retracted state in the base 10 to an extended state upon application of a force (i.e. a tension force) to the free end region 23 of the respective retractable line 20 by the user. The retractable lines 20 are arranged in the base 10 spaced apart from one another by a distance in the range of about 1.0 m to 1.2 m, and preferably about 1.1 m, for comfortable ergonomic operation by each hand and/or arm of a user when the user is standing, sitting, or lying on the upper surface 11 of the base 10.

Still referring to FIGS. 1 and 2, the fitness training apparatus 100 also comprises two load generators 30 provided in the base 10, each of the load generators 30 being operatively associated with a respective one of the two retractable lines 20 for applying a selectively adjustable load to that retractable line 20. To this end, each load generator 30 of the fitness training apparatus 100 comprises at least one electric motor 31, such as a torque motor, that is variably operable to generate a range of torques for applying the selectively adjustable load to its respective retractable line 20. The spool or drum 22 upon which the retractable line 20 is wound or coiled in the retracted state is mounted on a shaft 32 coupled with a rotor of the at least one electric motor 31. The load applied to each retractable line 20 by the respective load generator 30 resists or acts against a force applied in use to the free end region 23 by the user for extending the retractable lines 20 from the retracted state to the extended state. In this way, a user of the fitness training apparatus 100 can perform exercises with the retractable lines 20 against a selectively adjustable load provided by the load generators 30. The force typically required, in use, for application to the free end region 23 by the user for extending each cable 21 from its retracted state to its extended state will exceed the load being applied to the cable 21 by the respective load generator 30. Also, because the cables 21 are configured to be retracted from their extended state to their retracted state by the load applied by the electric motors 31, force applied to the cables 21 by the user performing exercises will oppose and/or resist the load being applied by the motors 31 for retracting the retractable lines 20 to the retracted state.

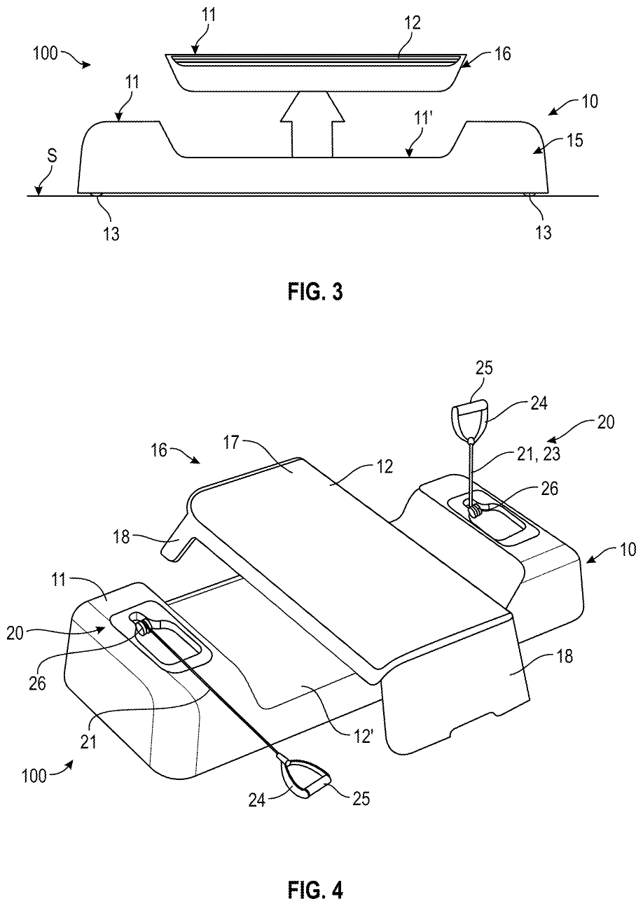

With reference also now to FIGS. 3 to 4 of the drawings, it will be appreciated that the base 10 of the fitness training apparatus 100 in this embodiment has an internal frame 14 for mounting and supporting the retractable lines 20 (i.e. in the retracted state) and the load generators 30, and an outer casing 15 that presents the upper surface 11 of the base and encloses and houses the retractable lines 20 and load generators 30. As noted above, the base 10 in this embodiment is configured as a platform or step upon which the user may stand, sit, or lie while performing training exercises. The step has a height H in the range of about 100 mm to 300 mm, preferably about 200 mm. The length L of the step is in the range of about 1.2 m to 1.4 m, preferably about 1.3 m, and the depth D of the step is in the range of about 400 mm to 600 mm, preferably about 500 mm. The retractable lines 20 are configured and arranged to be extended from the retracted state in a direction away from the base 10, preferably in an upwards or vertical direction, or through any of a range of angles to the vertical direction, or horizontally, as seen in FIG. 4. To this end, a path of travel of each retractable line 20 is guided by one or more pulleys 26 mounted in or on the base 10.

The base 10 of the fitness training apparatus 100 includes a portion 16 that is removable or separable to form a training bench for the user. The separable portion 16 of the base 10 has a bench panel 17 incorporating the layer 12 of rubberised material that provides grip and a degree of cushioning and/or comfort for the user, and foldable legs 18 in hinged attachment to opposite ends of the bench panel 17 for deployment to support the bench as shown in FIG. 4. The bench panel 17 has length in the range of about 500 mm to about 800 mm, preferably 600 mm, and may include space for storing the handles 24 or bar of the apparatus 100 when they are not in use (e.g. underneath the bench panel 17). As shown in FIG. 4 of the drawings, the base 10 includes a secondary upper surface 11′ with secondary layer 12′ of rubberised material for grip and a degree of cushioning and/or comfort for the user in the region below the separable portion 16 recessed between opposite ends of the base 10 respectively housing each of the retractable lines 20 and the load generators 30.

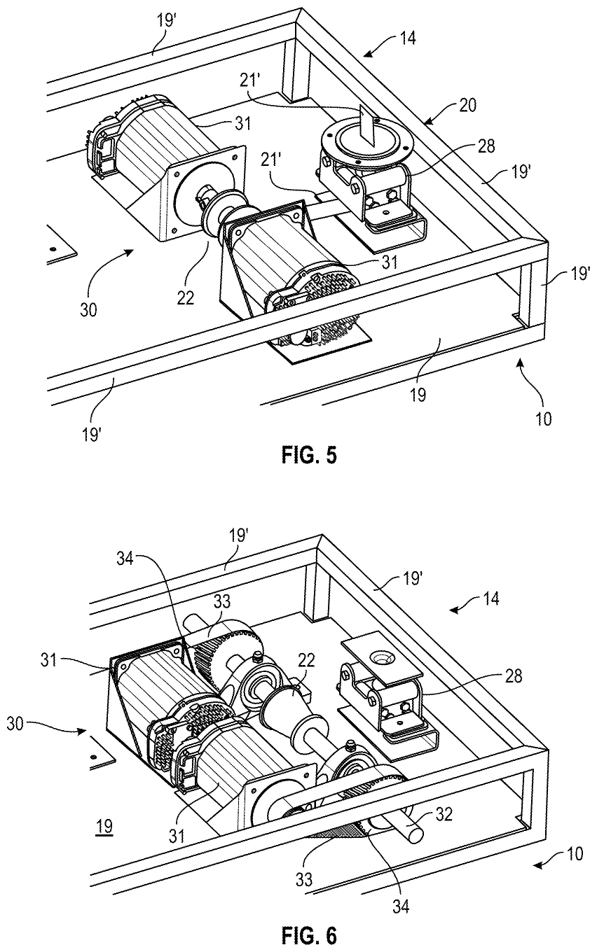

With reference to now FIGS. 5 to 10 of the drawings, alternative configurations for the retractable line 20 and its coupling with the load generators 30 are illustrated. As noted above, each of the load generators 30 has at least one electric motor 31. In each of these embodiments, however, dual electric motors 31 (torque motors) are preferred. Dual, uncoupled motors 31 allow the apparatus 100 to adjust to a weaker side, as will be described later. Dual motors 31 also help with torque production, and each motor 31 need only generate half the amount of torque for the total load. The power output of the motors 31 is based on a requirement to move up to 100 kg by a distance of 2 metres in 1 second, thereby giving a power requirement of about 2 kW. Allowing for some losses, two motors with a maximum power output of 1.2 kW each are contemplated. Where the spool or drum 22 for the cable 21 has a diameter of 50 mm, a shaft speed of 764 rpm for the spool 22 will equate to a 2 m extension of the cable 21 in 1 second. The torque for a 50 mm spool equates to 12.5 Nm per motor. A 50 mm diameter spool 22 with a cable 21 having a diameter of 5 mm demands a spool length of approx. 65 mm (i.e. 12.7 wraps of cable 21 side-by-side). A smaller spool 22 may be considered for greater range of shaft speed (rpm), if required. The RMS constant torque value is deemed a suitable operating value (as opposed to peak torque). The diameters of the pulleys 25 are calculated to suit this torque target point, and a maximum user force of 1000N.

Each of the drawing FIGS. 5 to 8 shows the dual electric motors 31 of the load generator 30 mounted on the frame 14 of the base 10 and coupled with the retractable line 20. The frame 14 comprises a plate 19 and elongate frame members 19′ on which the retractable line 20 and the load generator 30 are mounted in the base 10.

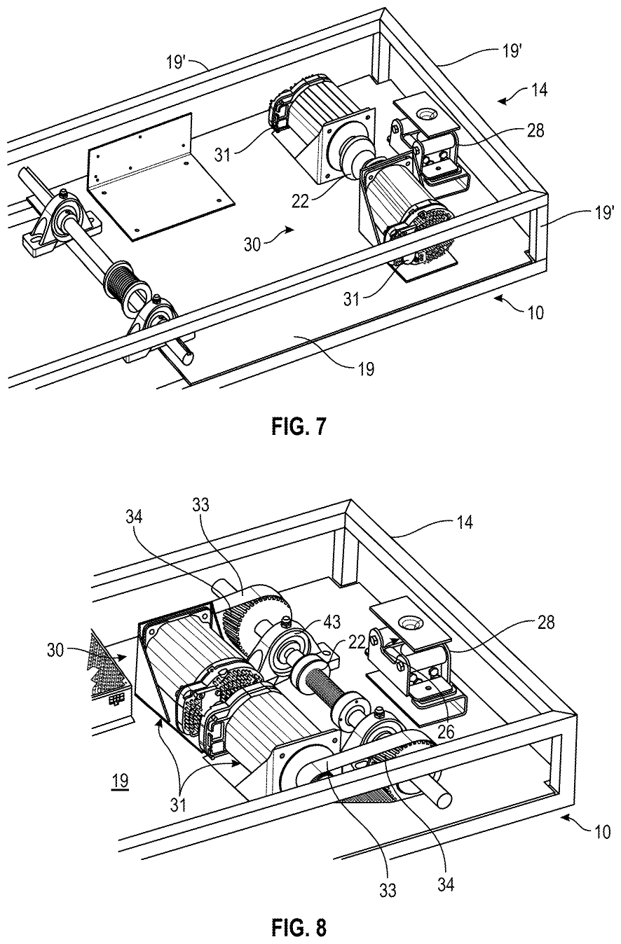

FIG. 5 shows an embodiment where the retractable line 20 comprises a flexible strap 21′ instead of a cable 21. The strap 21′ has the advantage of being a very flexible force translation material that can achieve a very small bend radius and has little or no chance of slip or movement when wound onto the spool or drum 22. The strap also provides a perception of smooth travel and quality as it is extended and retracted. However, as the strap winds on top of itself on the spool 22, the torque of the motors needs to vary as the diameter of the spool changes. The strap also has the potential for unwanted twisting, if not restrained. FIG. 6. shows an embodiment where the retractable line 20, and particularly the cable 21, is wound on a cone-shaped spool 22. The cable is circular in this example (i.e. as before) so there is no problem of inline twisting, as with strap. The cable 21 has a small profile and can be wound side-by-side, with the cone-shape promoting self-alignment of the cable on the spool 22. As such, there is no need for any inlet straightener, as required with the strap 21′. FIG. 7. shows an embodiment in which the cable 21 is wound via a capstan 27, which isolates the motors 31 of the load generator 30 from the spool. Again, the cable 21 is circular and therefore has little or no prospect of inline twisting, and the cable has a small profile for spooling side-by-side in a compact manner.

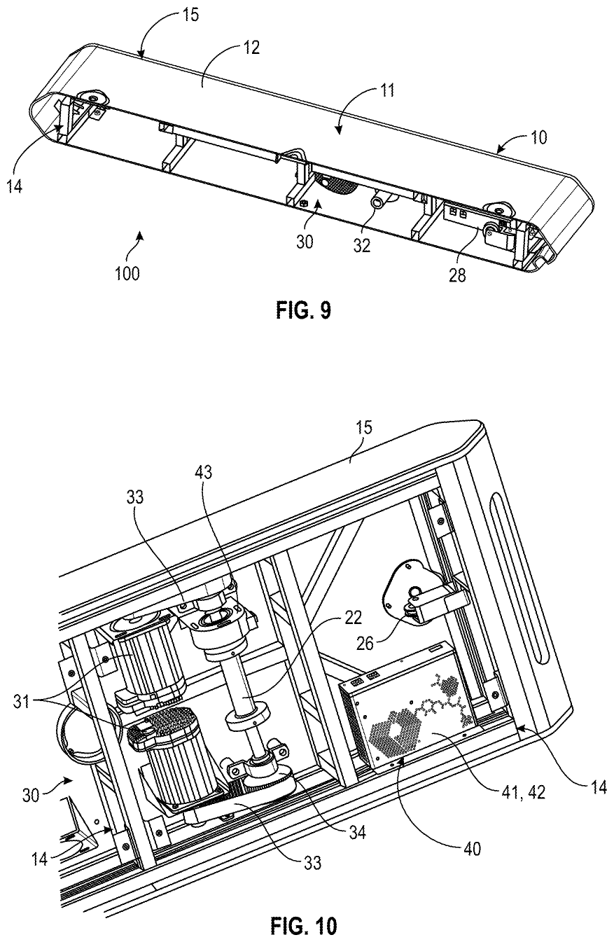

FIG. 8 of the drawings shows an embodiment in which the retractable line 20, and particularly cable or cord 21, is wound on a helical spool 22. The spool 22 thus has a helical groove providing a positive location for each winding of cable and the cable 21 is circular with little chance of inline twisting. Further, the cable 21 has a small profile and can be spooled side-by-side, with no need for a varying load calculation. Due to the proximity of the helical spool 22 to the cable pre-tensioner 28, a relatively large angle of travel is required for spooling over the length of the spool 22. To this end, the guide pulley 26 at the pre-tensioner is arranged to pivot or swivel about a vertical axis to guide cable 21 along the spool 22 as it winds and unwinds to prevent ‘jumping’ or overwinding of the cable 21 on spool 22 to achieve even spooling and no jamming/wedging. This embodiment is further illustrated in FIGS. 9 and 10. In this embodiment, the spool 22 is mounted on the shaft 32 coupled with the rotors of each motor 31 via a transmission, particularly a transmission comprising a toothed-belt (or chain) 33 and sprocket 34.

As will be seen in FIGS. 8 to 10 (and in FIG. 1), the fitness training apparatus 100 also has a control device 40 mounted or supported on the frame 14 of the base 10. The control device 40 includes a power supply circuit and hardware 41, a processor 42, wireless communication hardware, and one or more sensors 43 for sensing the use or operation of each retractable line 20. The sensors 43 include a rotary encoder (e.g. a Broadcom incremental encoder module, 500 CPR) for sensing/detecting rotation of the spool 22 for determining the position and speed of movement of each cable 21 as it is extended from or retracted onto its spool 22. The control device 40 is configured to adjust the load applied to each cable 21 by the motors 31 of the load generators 30 in dependence upon the use or operation of each retractable line 20. That is, the load generators 30 of the apparatus 100 are controlled via the control device 40 to adjust the load applied to cable 21 during extension of the cable 21 to the extended state and/or during retraction of the cable 21 to the retracted state. In this way, the load applied to the cable 21 by the electric motors 31 may be held constant, and/or increased, and/or decreased as the cable 21 is extended under the force applied by the user and/or as the cable 21 is retracted against the resistance force applied by the user. The adjustability of the load over the stroke or movement of the cable 21 in this way enables the training to be tailored to an individual user, but also to the specific exercise being trained and its biomechanics. So, each load generator 30 is able to be controlled to provide eccentric loading, concentric loading, and/or isometric loading, as desired.

According to a further embodiment of the present invention, a force measurement device (not shown) may be utilised to measure force applied to the cable 21. One example of a suitable force measurement device is a strain gauge, however any other device which measures force applied to an object is suitable. In use, the control device 40 controls the output of the motor 31, which applies tension on the cable 21. The force measurement device measures the force on the cable 21 and transmits such measurement to the control device 40. The control device 40 may then adjust instructions to the motor 31, so as to increase or reduce tension on the cable 21 as desired. Measurement by the force measurement device may occur continuously, or at set intervals (for example at startup or shutdown of the apparatus 100). Further, adjustment of the output of motor 31 may occur at regular intervals, or at discrete times as determined by control device 40.

According to another embodiment of the fitness training apparatus 100 P. Straps 21 (as illustrated in FIG. 4) may be connected with the ends of a bar 29 for a user to perform ‘squat’ exercises. Further, handle 24 may be in the form of a cuff for use on a forearm of a user for performing ‘arm curl’ exercises.

In a further improvement of the present invention the fitness training apparatus 100 may be combined with a user device, such as a display monitor and/or a smart phone. The user device is configured for communication with the apparatus 100, preferably via the control device, for the input of training settings by the user (e.g. via a smart phone or similar device) and/or for displaying training information to the user during training. In this regard, a software application installed on the user device for communication with the apparatus 100 for input of training settings and display of training information to the user. Furthermore, the control device 40, and particularly the processor 41, of the apparatus 100 is configured to calculate training performance based on the use of each cable 21 sensed or detected by the sensors 43 of the control device 40 for displaying the performance information on the user device 200. In this way, the control device 40 may output information to the user device for display to the user during training, thereby providing useful training feedback.

In a “velocity targeting” training mode, a speed band or speed range for motion of the cables 21 is employed to set or determine whether the workout is high intensity or low intensity. The lower the velocity target, the slower and heavier (the load) the user is lifting. In this regard, it is useful to target a band or range rather than a specific number or the load tends to waver up and down around the target. Speed is preferably set on a 1 ms pwm signal and the speed is sensed and adjusted every 50 ms. This could also optionally be lowered. The load may be varied linearly, or according to another function (e.g. a log function) if the motion falls out of the target band. Previous settings may also be stored to use as starting points.

The present invention may be configured for internet connectivity either via the control device 40 in the apparatus 100 and/or via the software application installed on the user device. This allows for connecting the user of the fitness training apparatus 100 to an interactive fitness environment. That is, the user can receive audio and/or visual input for one or more training regimes via the user device, and the user may be connected via a display monitor to a group or class training environment—either real or virtual. This input to the user may, for example, be in the form of instructor images (pre-recorded or real-time video) providing instruction and motivation transmitted onto the display monitor for any of various training regimes that may be selected by the user. The present invention may also have an interface for interaction with third party partner devices (e.g. Fitbit™, Apple™, Android™) for biometric review (e.g. of weight, BMI, heart-rate).

The present invention may include one or more accessory devices for user input (such as a camera and/or a microphone) and/or for output to the user (such as loud-speakers and/or lighting). In this regard, a camera enables external monitoring and/or review or social interaction, and a microphone provides for verbal communication by the user with training partners during training. The accessory devices may be integrated in the user device or may be separate. The present invention may also include a remote control (e.g. in addition to touch-screen actuation), optionally with IR input, and power/volume control for a user to operate the user device and/or accessory device(s) remotely during use of the fitness training apparatus 100.

The fitness training apparatus 100 could optionally be produced in a range of models having different load capabilities (e.g. light duty and heavy duty). To this end, the models could have same base 10 (i.e. the same frame 14 and casing 15) but with different motors 31; e.g. with force capacity of 500 N (e.g. approx. 50 kg) per cable 21; or with a force capacity of 1000 N (e.g. approx. 100 kg) per cable 21. The apparatus 100 of this embodiment preferably uses: Teknic MCVC integral HP single phase servo motors 31 in torque following mode; Velocio PLC and HMI screen; US Digital E6 optical incremental encoder; T10 16 mm steel core synchronous polyurethane belting and sprockets; Aluminium frame members 19, 19′. Cable connection ports (HDMI and USB) may be provided. An accessory shelf or pocket may be provided, e.g. for a drink-bottle, towel, phone, key, or the like.

In a further improvement of the present invention, illumination or other visible markers may be provided on the outside casing of the fitness training apparatus 100. These visible markers may serve to communicate to the user, or to any observers, the status of the fitness training apparatus. For example, in the case of illumination, the intensity or colour of the illumination may indicate a user's progression in a set or repetition of an exercise.

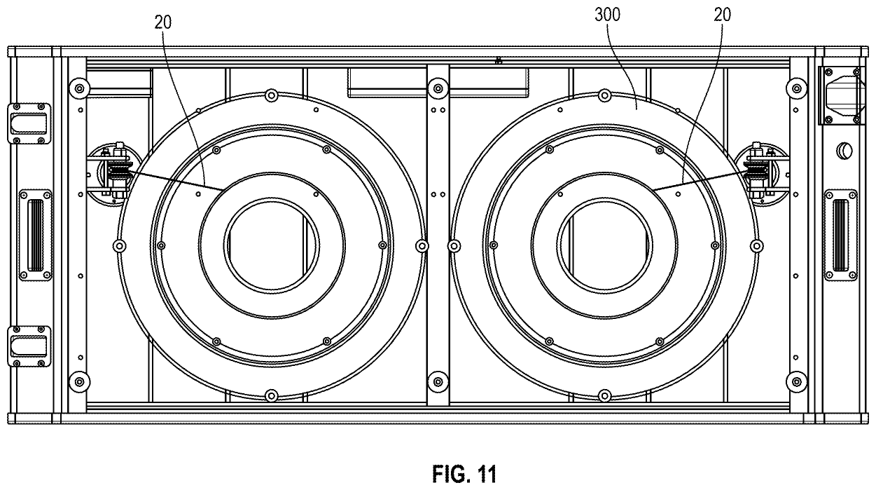

In a further improvement of the present invention, shown in FIG. 11, a direct drive motor 300 may be utilised in place of motor 31. A direct drive motor 300 is a form of motor which does not require a gear box, or pulley 26. The retractable line 20 is driven directly from the direct drive motor 300. The benefits of such a system include increased efficiency due to reduced friction over a traditional motor, reduced noise, a longer lifetime, and higher torque at lower revolutions per minute. Many forms of direct drive motors are suitable for the present invention, including but not limited to, frameless torque motors, brushless permanent-magnet synchronous motors, servo motors, and linear motors.

The present invention will now be described with reference to its software structure, and the ecosystem within which its software may communicate.

It will be recognised by a person of skill in the art that any form of computational power can be embedded within the fitness training apparatus 100. Many system-on-chip components exist which would be suitable, and possess the necessary computational power and memory to store data such as firmware and perform algorithmic computations.

The fitness training apparatus 100 generates data before, during, and after its use. This data may include, but is not limited, to:
1. Force;
2. Velocity;
3. Position; and
4. Time.

This data is communicated from the fitness training apparatus 100 to an application on a remote device. The remote device may be a phone, laptop, tablet, computer, or similar device. In order to communicate with the fitness training apparatus 100, a communication link is established between the fitness training apparatus 100 and the remote device. One suitable communication link is via the Bluetooth communication protocol, which is a wireless technology standard used for exchanging data between fixed and mobile devices over short distances using UHF radio waves in the industrial, scientific and medical radio bands, from 2.402 GHz to 2.480 GHz. More particularly, a suitable communication protocol is Bluetooth Low Energy (otherwise known as Bluetooth LE), which is a version of Bluetooth that consumes lower energy than traditional Bluetooth. Typically, a communication link between the remote device and the fitness training apparatus 100 is configured once and remains open for use whenever power is supplied to both the remote device and the fitness training apparatus 100. Data may be transmitted to the remote device at regular intervals, such as at 25 ms intervals.

The application on the remote device may send and receive data to or from the fitness training apparatus 100 and may be used by a user to control the fitness training apparatus 100. One example of control of the fitness training apparatus by the user is the selection of a training exercise for execution by the fitness training apparatus. In such an example, the user is presented by the application with choices of fitness training exercises. Upon selection by a user, the application on the remote device communicates with the fitness training apparatus 100 using the communication protocol as previously described, to provide the fitness training apparatus with any necessary variable values required such that the fitness training apparatus 100 may execute the chosen fitness training exercise.

Upon receipt by the fitness training apparatus 100 of variable values from the remote device, the fitness training apparatus 100 adjusts the load generators 30 to provide the desired load upon a retractable line 20, such that the selected training exercise on the remote device can function as intended.

It is desirable to be able to update the firmware located on the fitness training apparatus 100, such that the function of the fitness training apparatus 100 may be improved or otherwise adjusted. In order to facilitate such a firmware update, one possible method is as follows:
1. The firmware update is downloaded by the remote device.
2. The remote device sends a command via Bluetooth to the fitness training apparatus 100, instructing the apparatus to create a Wi-Fi network.
3. The fitness training apparatus 100 creates a Wi-Fi network and sends the login credentials for the Wi-Fi network to the remote device.
4. The remote device connects to the Wi-Fi network and starts a server.
5. The fitness training apparatus 100 connects to the server as a client and downloads the firmware update from the server.
6. When the download is complete, the fitness training apparatus 100 reboots. This operation cancels the Wi-Fi network.

### Selection of Exercise

The overall method for selecting a type of exercise on the fitness training apparatus 100 will now be described. A user connects the fitness training apparatus 100 to their remote device, as has been previously described. An application running on the remote device 100 displays to the user a list of exercises which may be performed on the fitness training apparatus 100. The application stores time-coded data for each exercise, describing exercise parameters at each time code. Upon selection of an exercise on the remote device by the user, the remote device sends a command to the fitness training apparatus 100 to commence the exercise. At each time code stored by the remote device, the desired parameters are sent to the fitness training apparatus 100. Suitable parameters include force, time, and velocity. Further, the remote device can track at which repetition of an exercise the user is presently at, and how many repetitions of the exercise have been performed. The remote device can further track the time taken to perform the exercise, the force overcome by the user during the exercise, and how many repetitions were performed by the user. This data may be stored, transferred, and/or compared against the user's previous data, or the data of other users. This comparison, or indeed the data itself, may be presented on the remote device or other connected device (such as a PC).

### Master Algorithm

Throughout the performance of a training exercise on the fitness training apparatus 100, it is desirable to determine the correct force which a user needs to overcome to achieve optimal training results. As this force differs based on the type of exercise and the position at which the user is in the exercise, it is proposed to determine a force curve 200 which is adapted over time based on a user's use of the fitness training apparatus 100.

In order to determine this force, The fitness training apparatus 100 controls the force for every centimetre, or similar distance measurement, the retractable line 20 travels. The force is analysed and matched to a desired force curve 200, such that the load generated by the load generator 20 may be modified to ensure the user receives a fitness benefit from the fitness training apparatus 100.

The fitness benefit is achieved through ensuring the user faces appropriate resistance in completing the exercise, at many points throughout the exercise. If the user is moving too quickly, or too slowly, through an exercise, fitting the outputted force/velocity to the desired force curve 200 will reveal in which direction adjustment to the load generators 30 must be made (i.e. increasing, or decreasing, the load). Over time the force curve 200 can be adjusted and matched to individual users, which may then be stored on the fitness training apparatus 100, or on the remote device.

At the commencement of an exercise, the velocity at which a user is moving through an exercise is determined against the position of the user in the exercise. The force on the retractable line 20 is then adjusted based on the force curve 200, and the user's velocity again examined against the position of the user in the exercise. An increase or decrease in the force on the retractable line 20 is then determined, in order to maintain optimal force on the retractable line 20. If too much force is applied to the retractable line 20, the user may not be able to progress in the exercise, essentially the user's velocity will become zero. If not enough force is applied to the retractable line 20, the user will move too easily through the exercise, and an optimal fitness benefit will not be obtained.

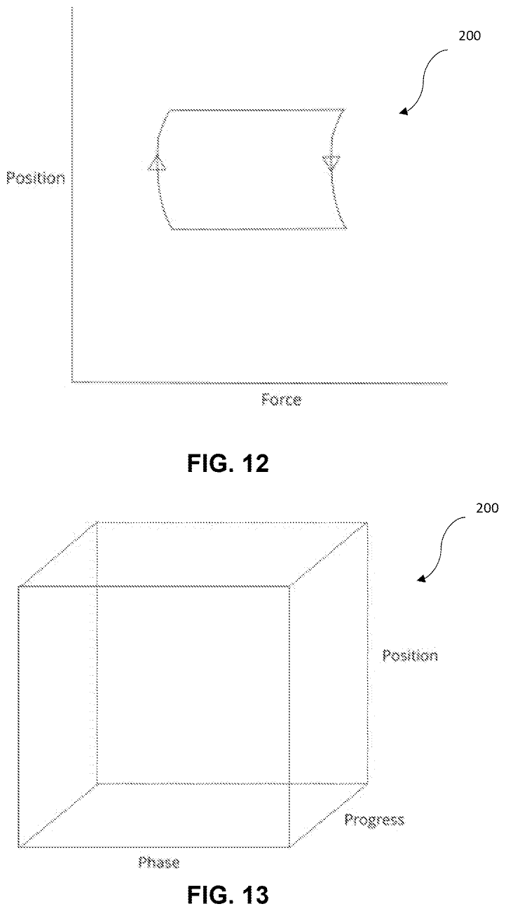

A force curve 200 for a bicep curl exercise is shown in FIG. 12.

### Force Cube

The fitness training apparatus 100 may be configured to provide variable force on the retractable lines 20 during an exercise. In order to configure and visualise this force, a force cube is used to demonstrate this function. Such force cubes are shown in FIGS. 13-15. The force cube is a 3-axis construct (as shown in FIG. 13), having an axis for progress, phase, and position. Progress is the user's progress through a set of exercises. Phase is whether the user is in a concentric or eccentric phase of the exercise. Position is the location of the user in the exercise. The force provides for 8 control points which may be adjusted by the fitness training apparatus, these 8 points represent the four corners of the force cube.

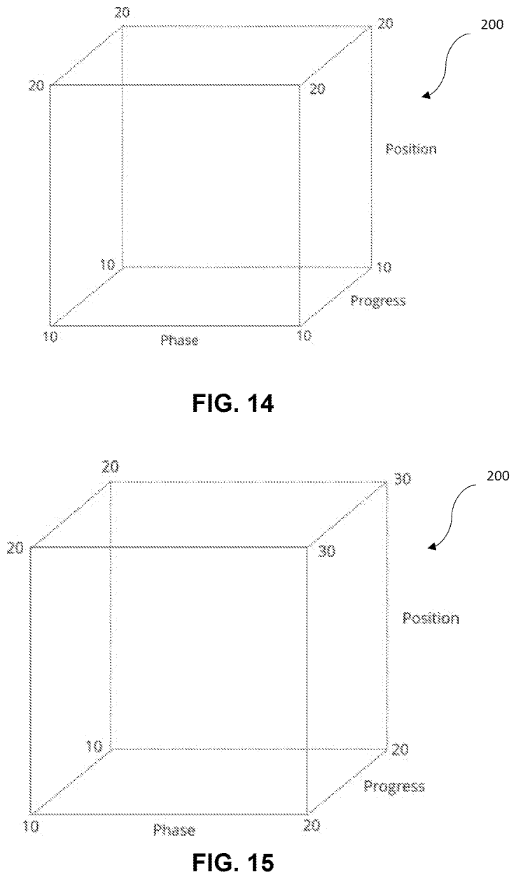

In order to demonstrate the force cube in action, FIG. 14 is provided which shows an exercise whereby the feeling of the “weight” on the retractable line 20 (i.e. the force) is light at the bottom of a repetition of an exercise, but heavy at the top of the exercise. FIG. 15 shows an exercise which has a peak “weight” at the top of the exercise, which then relaxes as the user moves down through the exercise. The values in FIGS. 13-15 represent kilograms.

### Safety Mode

In order to protect a user from harm, the fitness training apparatus 100 may have safety functionality such as the ability to remove force on the retractable lines 20 to a predetermined amount (for example the baseline value from the start of the exercise). This safety functionality may be triggered if the handle of a retractable line 20 at any point during an exercise advances past a factor below a user's range of motion, for example 5 centimetres.

### Tug of War Mode

Where two or more fitness training apparatus 100 are in communication via a network, such as the internet, or a local area network, it is possible for the two apparatus 100 to act in sync, or in response to one another. For example, it is possible to emulate a so-called “tug of war”, whereby a user on a first fitness training apparatus 100 may exert a pulling force on a retractable line 20, and a user on a second fitness training apparatus will fell that same force on their retractable line 20, pulling their retractable line 20 away from them toward their fitness training apparatus 100. This is achieved by the first fitness training apparatus 100 recording the force at which the user is pulling their retractable line 20 and communicating that force to the second fitness training apparatus 100 for reproduction.

### Lighting

In one embodiment of the present invention, lighting or illumination may be provided on the fitness training apparatus 100. For example, light emitting diodes (LEDs) may be provided along the sides of the fitness training apparatus 100. This lighting may be used to provide visual feedback to the user, for example the intensity of the illumination may alter as the user progresses through an exercise or as the force on the retractable lines 20 alters. Further, the colour of the illumination may be used to signal information to the user about the state of the device, such as if the device is powered on, active, resting, or resetting.

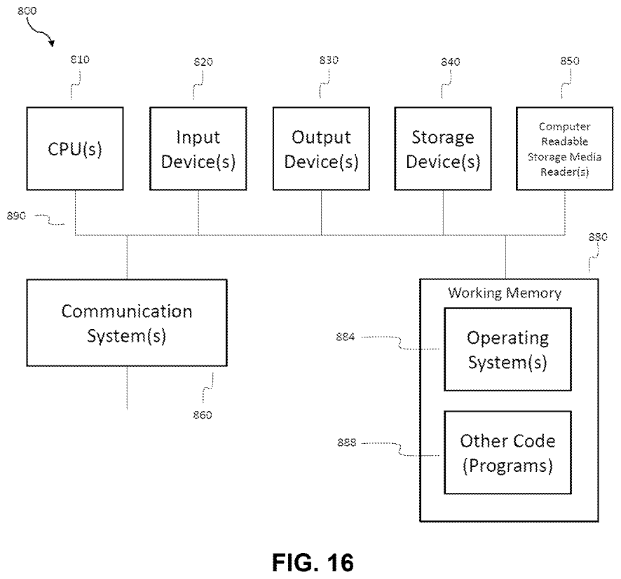

With reference to FIG. 16, provided is a block diagram illustrating an exemplary computer system 800 in which part or all of any of the embodiments of the present invention may be implemented. This example illustrates a computer system 800 such as may be used, in whole, in part, or with various modifications, to provide the functions of the systems and methods described above.

The computer system 800 is shown comprising hardware elements that may be electrically coupled via a bus 890. The hardware elements may include one or more central processing units 810, one or more input devices 820 (e.g., eye-tracking device, a mouse, a keyboard, a touchpad, a microphone, etc.), and one or more output devices 830 (e.g., a display device, a printer, etc.). The computer system 800 may also include one or more storage device 840. By way of example, storage device(s) 840 may be transitory and/or non-transitory disk drives, optical storage devices, solid-state storage device such as a random access memory (“RAM”) and/or a read-only memory (“ROM”), which can be programmable, flash-updateable and/or the like.

The computer system 800 may additionally include a computer-readable storage media reader 850, a communications system 860 (e.g., a modem, a network card (wireless or wired), an infra-red communication device, Bluetooth™ device, cellular communication device, etc.), and working memory 880, which may include RAM and ROM devices as described above. In some embodiments, the computer system 800 may also include a processing acceleration unit (not shown), which can include a digital signal processor, a special-purpose processor and/or the like.

The computer-readable storage media reader 850 can further be connected to a computer-readable storage medium, together (and, optionally, in combination with storage device(s) 840) comprehensively representing remote, local, fixed, and/or removable storage devices plus storage media for temporarily and/or more permanently containing computer-readable information. The communications system 860 may permit data to be exchanged with a network, system, computer and/or other component described above.

The computer system 800 may also comprise software elements, shown as being currently located within a working memory 880, including an operating system 884 and/or other code 888. It should be appreciated that alternate embodiments of a computer system 800 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 800 may include code 888 for implementing any or all of the function of the various elements of the architecture as described herein. For example, software, stored on and/or executed by a computer system such as system 800, can provide the functions of the methods and systems discussed above. Methods implementable by software on some of these components have been discussed above in more detail.

While the present invention described above will be understood to be directly applicable to use in the health and fitness sector, it will also be appreciated that they will be applicable or useful in the field of physical rehabilitation (e.g. following surgery or recovery from accident), as well as in the field of research, especially in relation to biomechanics and sport science.

Although specific embodiments of the invention are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that the terms “comprise”, “comprising”, “include”, “including”, “contain”, “containing”, “have”, “having”, and any variations thereof, used in this document are intended to be understood in an inclusive (i.e. non-exclusive) sense, such that the process, method, device, apparatus, or system described herein is not limited to those features, integers, parts, elements, or steps recited but may include other features, integers, parts, elements, or steps not expressly listed and/or inherent to such process, method, process, method, device, apparatus, or system. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects. In addition, reference to positional terms, such as “lower” and “upper”, used in the above description are to be taken in context of the embodiments depicted in the figures, and are not to be taken as limiting the invention to the literal interpretation of the term but rather as would be understood by the skilled addressee in the appropriate context.

1. A fitness training apparatus comprising:
a base;
at least one retractable line provided in or on the base, the retractable line having a free end region for operation by a user, wherein the at least one retractable line is configured and arranged to be extended from a retracted state in or on the base to an extended state upon application of a force to the free end region of the retractable line by the user;
a load generator provided in or on the base for applying a selectively adjustable load to the at least one retractable line, wherein the load applied to the retractable line by the load generator resists or acts against the force applied to the free end region by the user for extending the retractable line from the retracted state to the extended state;
a force measurement device to measure the load applied to the retractable line;
a processor for receiving data regarding the operation of the fitness training apparatus; and
a transmitter for transmitting information about the operation of the fitness training apparatus to a remote device.

2. A fitness training apparatus comprising:
a controller configured to communicate instructions to a load generator to apply a selectively adjustable load to at least one retractable line provided in or on a base, the retractable line having a free end region, the at least one retractable line being extendible from a retracted state to an extended state upon application of a force to the free end region, wherein the load applied to the at least one retractable line acts against the force applied to the free end region, wherein the controller is configured to perform operations comprising:
setting a target speed band for the at least one retractable line;
receiving a speed of the at least one retractable line; and
responsive to comparing the speed of the at least one retractable line to the target speed band, modifying the selectively adjustable load to the at least one retractable line to maintain the target speed band.

3. The fitness training apparatus of claim 2, wherein the controller comprises one or more sensors for sensing use or operation of the at least one retractable line, including sensing the speed of the at least one retractable line.

4. The fitness training apparatus of claim 2, wherein the controller comprises one or more sensors for sensing use or operation of the at least one retractable line, including sensing one or more of a current position, a motion, a speed, or an extension of the at least one retractable line, wherein the controller is configured to adjust the load applied to the at least one retractable line by the load generator in dependence on the use or operation of the at least one retractable line.

5. The fitness training apparatus of claim 2, wherein the controller is configured for communication with a user device for one or more of input of training settings by the user or displaying training information to the user during training.

6. The fitness training apparatus of claim 5, wherein the user device comprises software executing on the user device for communication with the controller.

7. The fitness training apparatus of claim 2, wherein the controller is configured to set the speed band responsive to receiving an input of a velocity target training setting.

8. The fitness training apparatus of claim 2, wherein the target speed band is defined by a minimum velocity and a maximum velocity.

9. The fitness training apparatus of claim 2, wherein modifying the selectively adjustable load to maintain the target speed band comprises varying the load according to a function.

10. The fitness training apparatus of claim 9, wherein the function comprises a linear function.

11. The fitness training apparatus of claim 9, wherein function comprises a log function.

12. The fitness training apparatus of claim 2, wherein the one or more sensors comprise at least a rotary encoder for detecting rotation of a spool or drum for determining the speed of the at least one retractable line as it is extended from or retracted onto the spool or drum.

13. The fitness training apparatus of claim 2, wherein the controller modifies the load applied to the at least one retractable line at regular intervals or at discrete times.

14. The fitness training apparatus of claim 2, wherein the at least one retractable line is connected with at least one end of a bar to enable performance of squat exercises.

15. The fitness training apparatus of claim 2, wherein a handle is connected to the free end of the at least one retractable line, wherein the handle comprises a cuff to enable performance of arm curl exercises.

16. A method, comprising:
setting, by a controller of a fitness training apparatus, a target speed band for a retractable line of the fitness training apparatus;
receiving, by a controller of a fitness training apparatus and from a sensor device, a speed of the retractable line;
responsive to comparing the speed of the retractable line to the target speed band, modifying, by the controller of the fitness training apparatus, a selectively adjustable load to the retractable line to maintain the target speed band, wherein modifying the selectively adjustable load comprises communicating instructions to a load generator to modify the selectively adjustable load to the retractable line.

17. The method of claim 16, wherein setting the target speed band comprises receiving, from a user device, instructions to apply a targeted velocity mode for the fitness training apparatus.

18. The method of claim 16, wherein modifying the selectively adjustable load to maintain the target speed band comprises varying the load according to a function.

19. The method of claim 18, wherein the function comprises a linear function.

20. The method of claim 18, wherein function comprises a log function.

21. The method of claim 16, wherein the sensor comprises a rotary encoder for detecting rotation of a spool or drum for determining the speed of the retractable line as it is extended from or retracted onto the spool or drum.
